(19) United States
(12) Patent Application Publication
(10) Pub. No.: US 2023/0169500 A1
(43) Pub. Date: Jun. 1, 2023

(54) MICROSERVICE-BASED MULTIFACTOR AUTHENTICATION

(71) Applicant: Cisco Technology, Inc., San Jose, CA (US)

(72) Inventors: Walter Theodore Hulick, JR., Pearland, TX (US); David John Zacks, Vancouver (CA); Thomas Szigeti, Vancouver (CA); Renato Scaglioni Quedas, Chicago, IL (US)

(21) Appl. No.: 17/535,957

(22) Filed: Nov. 26, 2021

(51) Int. Cl. G06Q 20/40

(52) U.S. Cl. CPC G06Q 20/401

(57) ABSTRACT

In one embodiment, a microservice, that provides one or more services for one or more distributed business transactions offered by an application, obtains a service request for a particular business transaction involving a particular user device executing the application. The microservice determines whether the service request includes an indication of authentication results for the particular business transaction that satisfy one or more authentication requirements of the microservice. The microservice sends, based on the indication of authentication results for the particular business transaction not satisfying the one or more authentication requirements of the microservice, a request for the particular user device to perform authentication for the particular business transaction to satisfy the one or more authentication requirements. The microservice completes, based on the indication of authentication results for the particular business transaction satisfying the one or more authentication requirements of the microservice, a particular service as per the service request.

### TECHNICAL FIELD

The present disclosure relates generally to computer systems, and, more particularly, to microservice-based multifactor authentication.

### BACKGROUND

Microservices provide a variety of web services, processes, etc. that are related to or part of a web application transaction. From the perspective of the web application, authentication of the end user's identify may be essential to determining whether a particular transaction should be performed by the web application and associated microservices. Generally, authentication (e.g., multifactor authentication) occurs at an end user-facing part of a web application, for example, a user interface when the user begins using the web application. Oftentimes, however, microservices are employed after authentication of an end user's identity has already been performed by the web application.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example architecture for a microservice-based multifactor authentication;

FIG. 5 illustrates an example message flow diagram for microservice-based multifactor authentication; and

FIG. 6 illustrates an example simplified procedure for microservice-based multifactor authentication in accordance with one or more embodiments described herein.

### DESCRIPTION OF EXAMPLE EMBODIMENTS

### Overview

According to one or more embodiments of the disclosure, a microservice, that provides one or more services for one or more distributed business transactions offered by an application, obtains a service request for a particular business transaction involving a particular user device executing the application. The microservice determines whether the service request includes an indication of authentication results for the particular business transaction that satisfy one or more authentication requirements of the microservice. The microservice sends, based on the indication of authentication results for the particular business transaction not satisfying the one or more authentication requirements of the microservice, a request for the particular user device to perform authentication for the particular business transaction to satisfy the one or more authentication requirements. The microservice completes, based on the indication of authentication results for the particular business transaction satisfying the one or more authentication requirements of the microservice, a particular service of the one or more services as per the service request.

Other embodiments are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

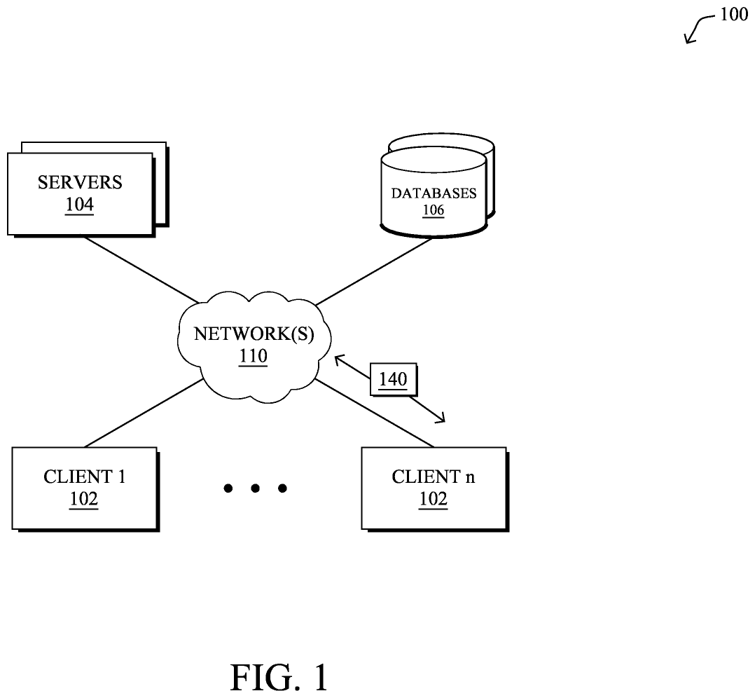

FIG. 1 is a schematic block diagram of an example (simplified) computing system 100 illustratively comprising any number of client devices 102 (e.g., a first through nth client device), one or more servers 104, and one or more databases 106, where the devices may be in communication with one another via one or more networks 110. The one or more networks 110 may include, as would be appreciated, any number of specialized networking devices such as routers, switches, access points, etc., interconnected via wired and/or wireless connections. For example, client devices 102 and/or the intermediary devices in one or more networks 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via one or more networks 110.

Notably, in some embodiments, one or more servers 104 and/or one or more databases 106, including any number of other suitable devices (e.g., firewalls, gateways, and so on) may be part of a cloud-based service. In such cases, the servers and/or one or more databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

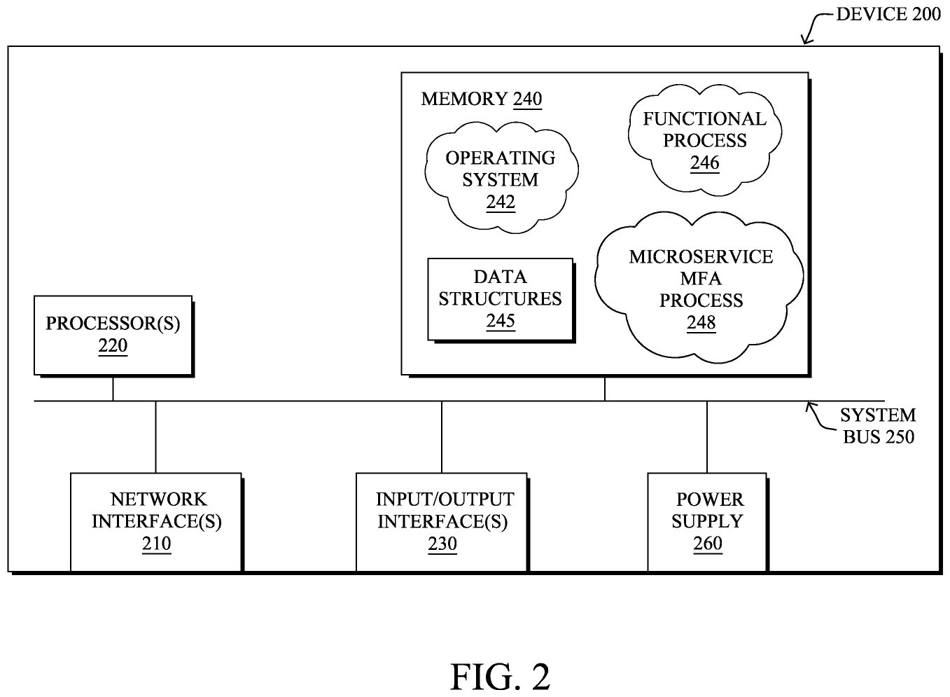

FIG. 2 is a schematic block diagram of an example node/device 200 that may be used with one or more embodiments described herein, e.g., as any of the client devices 102, one or more servers 104, one or more databases 106 shown in FIG. 1 above. Device 200 may comprise one or more network interfaces 210 (e.g., wired, wireless, etc.), at processor(s) 220, and a memory 240 interconnected by a system bus 250, as well as a power supply 260 (e.g., battery, plug-in, etc.).

One or more network interfaces 210 contain the mechanical, electrical, and signaling circuitry for communicating data over links coupled to the one or more networks 110. The network interfaces may be configured to transmit and/or receive data using a variety of different communication protocols. Note, further, that device 200 may have multiple types of network connections via one or more network interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor(s) 220 and the one or more network interfaces 210 for storing software programs and data structures associated with the embodiments described herein. The processor(s) 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise one or more functional processes 246, and on certain devices, microservice multifactor authentication process 248, as described herein. Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

### Observability Intelligence Platform

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more embodiments herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

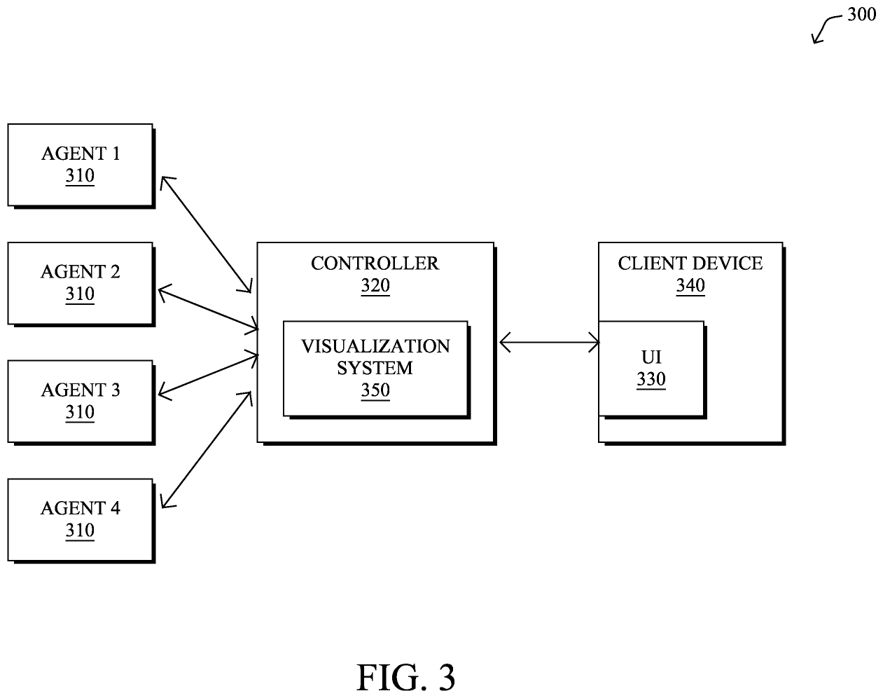

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable embodiment of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents 310 and one or more servers or controllers 320. Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controllers 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controllers 320 is the central processing and administration server for the observability intelligence platform. The controllers 320 may serve a browser-based user interface (UI) 330 that is the primary interface for monitoring, analyzing, and troubleshooting the monitored environment. Specifically, the controllers 320 can receive data from one or more agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controllers 320 to view an interface for monitoring data. The controllers 320 can include a visualization system 350 for displaying the reports and dashboards related to the disclosed technology. In some implementations, the visualization system 350 can be implemented in a separate machine (e.g., a server) different from the one hosting the controllers 320.

Notably, in an illustrative Software as a Service (SaaS) implementation, a controller instance of controllers 320 may be hosted remotely by a provider of the observability intelligence platform 300. In an illustrative on-premises (On-Prem) implementation, a controller instance of controllers 320 may be installed locally and self-administered.

The controllers 320 receive data from one or more agents 310 (e.g., Agents 1-4) deployed to monitor networks, applications, databases and database servers, servers, and end user clients for the monitored environment. Any of one or more agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain embodiments, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one embodiment, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain embodiments, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

### Microservice-based Multifactor Authentication

As noted above, microservices provide applications, for example, distributed web or business applications, access to independent components that run processes as services (e.g., over an API). Due to their independent nature, microservices can be updated, deployed, and scaled to meet demand for a plurality of applications. Examples of services that a microservice may provide may include payment processing, product/service tracking, comment posting on a website, etc. Oftentimes, microservices are employed at an application layer (e.g., by a web application or a distributed business application at a “mid-tier”), after authentication of an end user's identity is verified that is conventionally done using JavaScript Object Notation (JSON) web tokens, as understood by one having ordinary skill in the art. From the perspective of the business application, authentication of the end user's identify may be essential to determining whether a particular business transaction is to be performed by business applications and associated microservices.

Authentication (e.g., multifactor authentication) occurs at an end user-facing part of a web application, for example, a user interface when the user begins using the web application. For example, authentication occurs when a user signs in to a website, prior to confirming a purchase, etc. Microservices, however, are typically excluded from authentication processes that may occur for web applications. Specifically, due to the nature of their implementation, microservices have no visibility into where in a web application transaction authentication may have occurred and lack the ability to force it be performed (through a web application).

The techniques herein, therefore, provide mechanisms to enable microservice-based authentication (e.g., multifactor authentication). Notably, in addition to parsing through JSON web tokens to determine whether to provide a service to web application (by verifying authentication credentials), microservices herein may be configured to evaluate JSON web tokens to determine whether authentication has taken place for particular web application transactions, that is, authentication that specifically satisfies a required authentication for the microservice, as described in greater detail below. If adequate authentication has not taken place, a microservice may be configured to trigger a web application to perform it. In other words, microservices may be configured to review additional security information found in JSON web tokens and to request authentication using JSON web tokens in a “full duplex” manner, prior to performing a service, process, etc. that the microservices provide. The ability to prompt performance of authentication may be altered based on, for example, a sensitivity or importance level associated with a particular microservice (i.e., level of security required). In addition, details regarding the nature of an authentication process that occurred at a web application (e.g., type, timing, etc.) may be communicated to a microservice using JSON web tokens, and the microservice may be configured to prompt performance of authentication, of a particular type or level, based on whether this information satisfies requirements of microservice operators.

Microservices, accordingly, are provided “partial” ownership of web application transactions, instead of just a web application owner (or operator). Given the increased use and reliance of microservices, for example, as part of “microservice farms” or in cloud native environments, microservices are enabled with additional abilities to ensure that the services they provide should proceed. Specifically, microservice owners/operators may determine whether authentication performed at an application layer (e.g., a “mid-tier”) is satisfactory. Such ability provides additional visibility to owners/operators as well as protection from security breaches and, potentially, liability in the case of malicious activity.

Specifically, and as described in greater detail below, according to one or more embodiments described herein, a microservice, that provides one or more services for one or more distributed business transactions offered by an application, obtains a service request for a particular business transaction involving a particular user device executing the application. The microservice determines whether the service request includes an indication of authentication results for the particular business transaction that satisfy one or more authentication requirements of the microservice. The microservice sends, based on the indication of authentication results for the particular business transaction not satisfying the one or more authentication requirements of the microservice, a request for the particular user device to perform authentication for the particular business transaction to satisfy the one or more authentication requirements. The microservice completes, based on the indication of authentication results for the particular business transaction satisfying the one or more authentication requirements of the microservice, a particular service of the one or more services as per the service request.

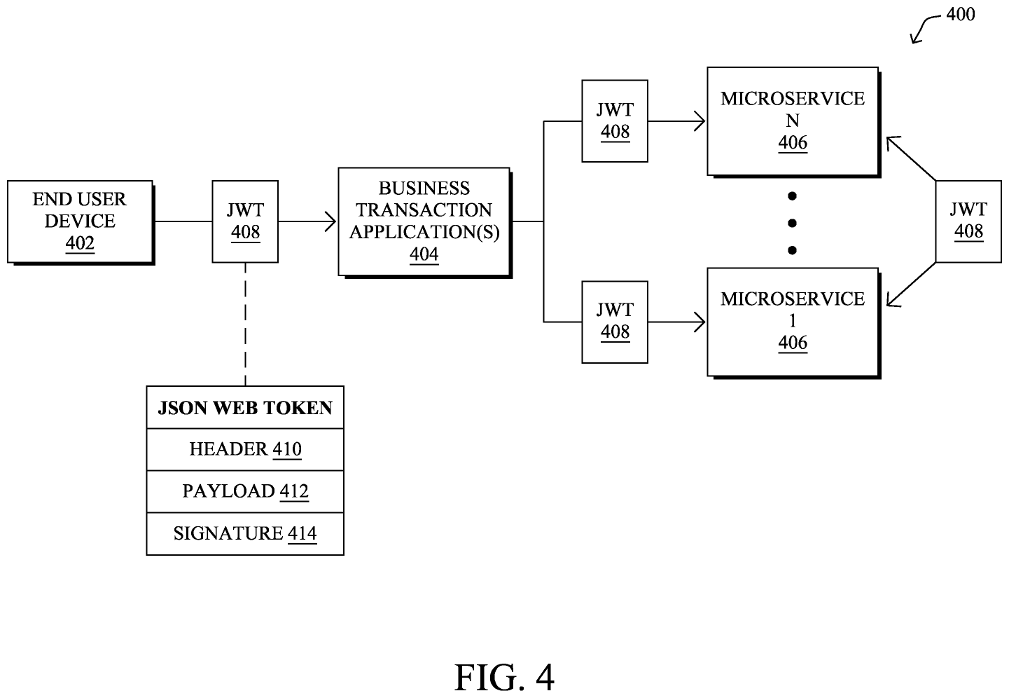

Operationally, FIG. 4 illustrates an example architecture 400 of microservice-based multifactor authentication. Architecture 400 may comprise end user device 402, one or more distributed business transaction applications 404, and plurality of microservices 406. Generally, an end user at end user device 402 may use end user device 402 to initiate, complete, participate in, etc. an instance of a distributed business transaction which one or more distributed business transaction applications 404 is configured to perform. As described herein above, the end user may purchase a good or service via an e-commerce platform, initiate a stock transaction, etc., all of which may be understood as a business transaction.

One or more distributed business transaction applications 404 may be configured to initiate one or more authentication processes, to be completed by an end user at end user device 402, for a particular business transaction. In particular, as is understood in the art, authentication of an identity of the end user is essential to prevent fraud, unintended purchases, etc. from occurring due to accidents or even malicious activity. Such authentication processes may include multifactor authentication that requires multiple methods of authentication from independent categories of credentials to verify an end user's identity for a login or other transaction. As is understood in the art, multifactor authentication may combine two or more independent credentials (e.g., a user password as well a security token obtained from an authenticator application, SMS, facial recognition or other biometrics, etc.).

To perform a particular business transaction, one or more distributed business transaction applications 404 may further leverage one or more microservices offered by plurality of microservices 406. Notably, microservices have become an integral part of the application development and deployment landscape, especially for distributed business transaction applications. Microservices may be understood as providing individual services that are related to or part of a distributed business transaction, for example, payment processing/tracking, information gathering, supply chain monitoring, data sharing and/or processing, etc.

Additionally, services provided by microservices do not all require the same amount of information regarding a particular transaction in that some perform services that are sensitive in nature and, thus, require a higher level of authentication, while others do not. Some examples include money transfers (e.g., any transfer or transfers above a certain amount, etc.), administrative changes to accounts, access to data or files, etc., as opposed to comment posting on a forum, location checking, etc. Furthermore, plurality of microservices 406 may be bundled in container and images as well as being offered as a part of a cloud native environment that is separately managed and operated from one or more distributed business transaction applications 404.

As shown, one or more JSON web tokens 408, also known as “JWTs”, may be communicated among end user device 402, one or more distributed business transaction applications 404, and plurality of microservices 406, where one or more JSON web tokens 408 can be understood as information (or metadata) that is distributed among these components. In particular, JWTs are conventionally used for authentication between one or more distributed business transaction applications 404, and plurality of microservices 406. Notably, authentication using a JWT may include validation of another microservice, a distributed business transaction application, an end user device, etc. to allow these components to interoperate with each other securely.

A particular JWT may be carried in an HTTP Authorization header that is encrypted using, for example, secure sockets layer (SSL) or transport layer security (TLC). It is contemplated that the particular JWT may be included in any other header. As shown, a particular JWT of one or more JSON web tokens 408 may be understood as a data structure including three parts (that are readable after decryption), including JWT header 410, JWT payload 412, and JWT signature 414. These parts may be concatenated Base64url-encoded strings that are separated by dots (.).

JWT header 410 may include metadata about a type of token (e.g., a JWT) and one or more cryptographic algorithms used to secure content of a JWT contents. Oftentimes, this information is indicative of a token type and a signing algorithm.

JWT payload 412 may include claims; in other words, verifiable security statements, such as an identity of a user and permissions that the user is allowed. This is often indicated by key-value pairs. This signed information (e.g. supplier, signing authority, subject, etc.) is verified by microservices 406 to determine whether a service, process, etc. offered by microservices 406 is to occur. As will be described in greater detail herein, JWT payload 412 may additionally be configured to include information regarding authentication for a particular transaction offered by one or more distributed business transaction applications 404. That is additional key-value pairs may be included in JWT payload 412 that are indicative of authentication that has been performed between end user device 402 and one or more distributed business transaction applications 404 for a particular transaction. Such information may be indicative of whether authentication occurred, a type of authentication, a level of authentication; a timestamp, an expiration timer, etc. Example custom claims could be: “performed-mfa: yes”, “microservice-403-reason: perform-mfa”, “perform-mfa-stamp:epoch time”, etc.

JWT signature 414 may include a signature that is used to validate a particular JWT, where validation is indicative of a token's trustworthiness. That is, the signature may be used to determine whether a token has been tampered with.

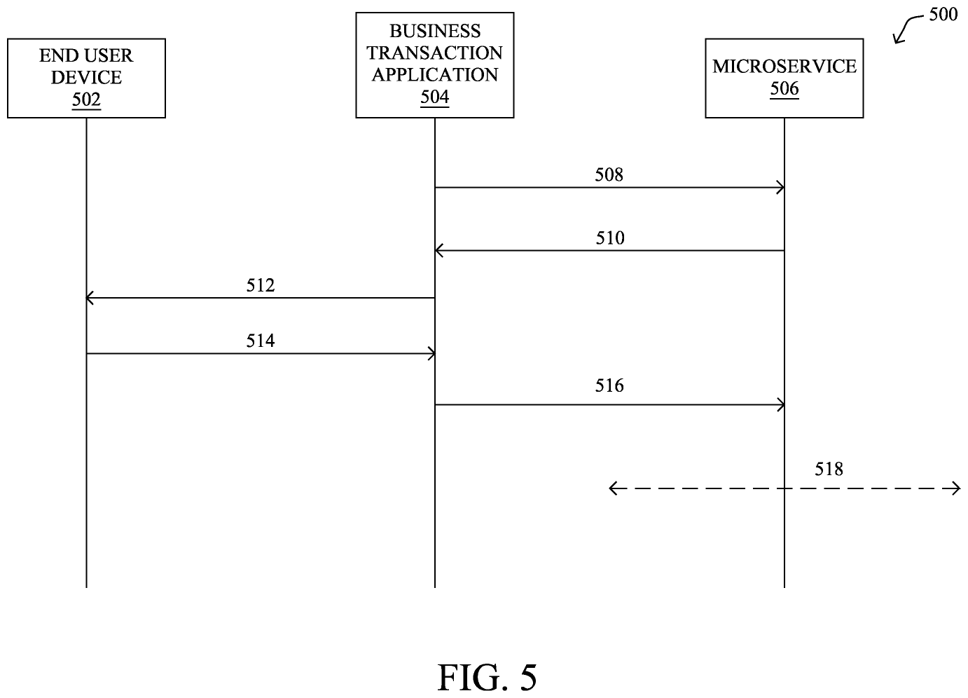

FIG. 5 illustrates an example message flow diagram 500 for microservice-based multifactor authentication. In particular, an end user using may interact with end user device 502 interface with business transaction application 504. At end user device 502, the end user may initiate a transaction (e.g., a particular business transaction), for example, to purchase an item, start a service, etc. offered by business transaction application 504. In performing the transaction, initiated by the end user at end user device 502, business transaction application 504 may be configured to engage with microservice 506 to complete the transaction. In doing so, business transaction application 504 may send a request for service 508, using a JSON web token, to microservice 506.

Microservice 506, upon receipt of request for service 508 (e.g., a JSON web token), may parse through request for service 508 to determine whether request for service 508 includes information indicative of whether sufficient authentication has occurred by business transaction application 504. Alternatively, microservice 506 may analyze the information in request for service 508 satisfies other requirements (prior to providing a service, process, etc.).

That is, as described above herein, microservice 506 may determine whether, for example, claims of a JSON web token indicate that whether a particular authentication has occurred that satisfies various security requirements of the particular microservice. That is, microservice 506 may be configured to determine whether the authentication occurred matches or satisfies a particular type of the authentication (multifactor with biometrics, PIN/password, etc.) or a level of authentication. Additionally, microservice 506 may determine whether claims in the JSON web token include a timestamp associated with authentication or a timer, all of which may be used to determine whether the authentication may still be considered satisfactory or valid (e.g., timely, strong/secure enough, and so on).

It is further contemplated that not all microservices may be configured to perform such authentication checks in their entirety. That is, based on a sensitivity, importance, etc. level associated with the service, process, etc. offered by a microservice, microservice 506 may be configured to check for the presence of certain information in the JSON web token. In one example, a microservice associated with a lower level of security, may only determine whether authentication has occurred. Transactions involving monetary transfers or highly personal data may require more stringent checks, so a microservice may be associated with a higher level of security. Such microservice may determine whether authentication has occurred in addition to determining whether the authentication is of a particular type and/or level.

In situations where request for service 508 contains authentication information that indicates authentication did not occur (or does not satisfy other requirements of microservice 506), microservice 506 sends MFA request 510 to business transaction application 504. MFA request 510 may comprise a response such as an HTTP 403 forbidden response that is indicative of a requirement of microservice 506 for authentication, in particular multifactor authentication, to be performed by business transaction application 504 with end user at end user device 502 for a particular transaction. After receiving MFA request 510, business transaction application 504 may exchange, for example, message 512 and message 514, to perform authentication. Business transaction application 504 may then generate another service request 516 that includes authentication information required by microservice 506.

After receiving another (returned/responsive) service request 516, microservice 506 may then parse it to verify that other service request 516 now contains the information required related to authentication between end user device 502 and business transaction application 504. In response to this updated request 516, or else in response to an original request carrying a satisfactory authentication, microservice 506 may then proceed with sending one or more messages 518 to complete the service, process, etc. requested by business transaction application 504.

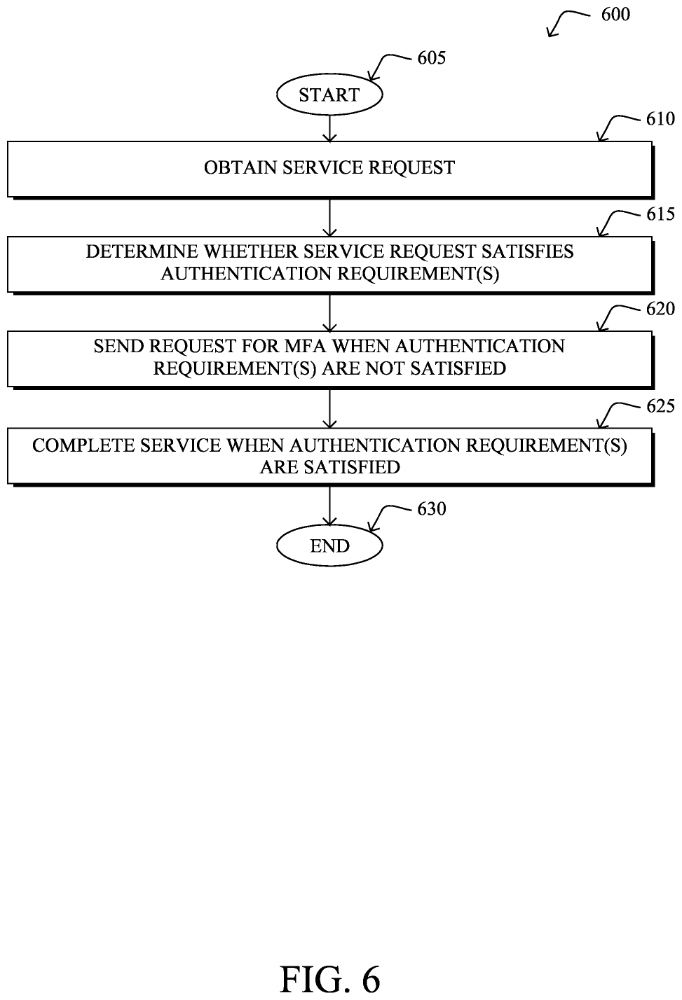

In closing, FIG. 6 illustrates an example simplified procedure for microservice-based multifactor authentication in accordance with one or more embodiments described herein, particularly from the perspective of either an edge device or a controller. For example, a non-generic, specifically configured device (e.g., device 200) may perform procedure 600 by executing stored instructions (e.g., microservice multifactor authentication process 248). The procedure 600 may start at step 605, and continues to step 610, where, as described in greater detail above, a microservice that provides one or more services for one or more distributed business transactions offered by an application may obtain/receive a service request for a particular business transaction involving a particular user device executing the application. In some embodiments, the service request may comprise a JavaScript object notation (JSON) web token. In some embodiments, the microservice is offered as part of a cloud native environment. In further embodiments, the microservice may be separately managed and operated from the application. In some embodiments, the microservice may offer a service selected from a group consisting of: payment processing; product or service tracking; data or file access; and comment posting.

At step 615, the microservice may determine whether the service request includes an indication of authentication results for the particular business transaction that satisfy one or more authentication requirements of the microservice. In some embodiments, the indication of authentication results may be selected from a group consisting of: an indicator of authentication results; a type of authentication; a level of authentication; a timestamp of when authentication was performed; and a timer associated with authentication. In some embodiments, the microservice may have an associated level of security, where the level of security indicates whether the microservice should implement and/or have the ability to check whether authentication has been performed by the application (e.g., based on a type of authentication or level of authentication that is performed).

At step 620, the microservice may send, based on the indication of authentication results for the particular business transaction not satisfying the one or more authentication requirements of the microservice, a request for the particular user device to perform authentication for the particular business transaction to satisfy the one or more authentication requirements. In some embodiments, the request for the particular user device to perform the authentication for the particular business transaction to satisfy the one or more authentication requirements comprises an HTTP 403 forbidden response. Particularly, such response may cause the application to perform an authentication process with an end user of the application (e.g., to authenticate an identity of the end user for the distributed business transaction using authentication of a particular type or at a particular level).

At step 625, the microservice may complete, based on the indication of authentication results for the particular business transaction satisfying the one or more authentication requirements of the microservice, a particular service of the one or more services as per the service request.

The procedure 600 may then end in step 630, notably with the ability to continue processing one or more service requests with the ability to determine whether authentication has occurred, and so on. Other steps may also be included generally within procedure 600.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for microservice-based multifactor authentication. In particular, in addition to offering a service, process, etc. associated with a web application, the techniques herein configure microservices to determine whether satisfactory authentication has been performed for a particular web transaction. Of note, microservices typically parse JSON web tokens to verify authentication credentials (e.g., microservice-specific) prior to completing a corresponding service, process, etc. The techniques herein allow microservices to identify additional indicators (within a payload of a JSON web token) of whether such authentication has been performed, as well as a type, timing, level, etc. of the authentication. In other words, the microservice may cause a web application to initiate an authentication process, where none has been performed, or else may cause a web application initiate another (e.g., a more scrutinizing, more recent, more secure, etc.) authentication process should the microservice determine that the desired authentication has not been satisfactorily performed.

In still further embodiments of the techniques herein, a business impact of the authentication can also be quantified. That is, because of issues related to specific applications/processes (e.g., lost traffic, slower servers, overloaded network links, etc.), various corresponding business transactions may have been correspondingly affected for those applications/processes (e.g., online purchases were delayed, page visits were halted before fully loading, user satisfaction or dwell time decreased, etc.), while other processes (e.g., on other network segments or at other times) remain unaffected. The techniques herein, therefore, can correlate the authentication with various business transactions in order to better understand the effect on the business transactions, accordingly.

Illustratively, the techniques described herein may be performed by hardware, software, and/or firmware, such as in accordance with microservice multifactor authentication process 248, which may include computer executable instructions executed by the processor(s) 220 to perform functions relating to the techniques described herein, e.g., in conjunction with corresponding processes of other devices in the computer network as described herein (e.g., on network agents, controllers, computing devices, servers, etc.). In addition, the components herein may be implemented on a singular device or in a distributed manner, in which case the combination of executing devices can be viewed as their own singular “device” for purposes of executing the microservice multifactor authentication process 248.

According to the embodiments herein, an illustrative method herein may comprise: obtaining, at a microservice that provides one or more services for one or more distributed business transactions offered by an application, a service request for a particular business transaction involving a particular user device executing the application; determining, by the microservice, whether the service request includes an indication of authentication results for the particular business transaction that satisfy one or more authentication requirements of the microservice; sending, by the microservice and based on the indication of authentication results for the particular business transaction not satisfying the one or more authentication requirements of the microservice, a request for the particular user device to perform authentication for the particular business transaction to satisfy the one or more authentication requirements; and completing, by the microservice and based on the indication of authentication results for the particular business transaction satisfying the one or more authentication requirements of the microservice, a particular service of the one or more services as per the service request.

In one embodiment, the service request comprises a JavaScript object notation (JSON) web token. In one embodiment, the request for the particular user device to perform the authentication for the particular business transaction to satisfy the one or more authentication requirements comprises an HTTP 403 forbidden response. In one embodiment, the indication of authentication results is selected from a group consisting of: an indicator of authentication results; a type of authentication; a level of authentication; a timestamp of when authentication was performed; and a timer associated with authentication. In one embodiment, the microservice has an associated level of security. In one embodiment, the microservice offers a service selected from a group consisting of: payment processing; product or service tracking; data or file access; and comment posting. In one embodiment, the microservice is offered as part of a cloud native environment. In one embodiment the microservice is separately managed and operated from the application.

According to the embodiments herein, an illustrative tangible, non-transitory, computer-readable medium herein may have computer-executable instructions stored thereon that, when executed by a processor on a computer, cause a microservice that provides one or more services for one or more distributed business transactions offered by an application to perform a method comprising: obtaining a service request for a particular business transaction involving a particular user device executing the application; determining whether the service request includes an indication of authentication results for the particular business transaction that satisfy one or more authentication requirements of the microservice; sending, based on the indication of authentication results for the particular business transaction not satisfying the one or more authentication requirements of the microservice, a request for the particular user device to perform authentication for the particular business transaction to satisfy the one or more authentication requirements; and completing, based on the indication of authentication results for the particular business transaction satisfying the one or more authentication requirements of the microservice, a particular service of the one or more services as per the service request.

Further, according to the embodiments herein an illustrative apparatus herein may comprise: one or more network interfaces to communicate with a network; a processor coupled to the network interfaces and configured to execute one or more processes; and a memory configured to store a process that is executable by the processor, the process, when executed, configured to: obtain, at a microservice that provides one or more services for one or more distributed business transactions offered by an application a service request for a particular business transaction involving a particular user device executing the application; determine whether the service request includes an indication of authentication results for the particular business transaction that satisfy one or more authentication requirements of the microservice; send, based on the indication of authentication results for the particular business transaction not satisfying the one or more authentication requirements of the microservice, a request for the particular user device to perform authentication for the particular business transaction to satisfy the one or more authentication requirements; and complete, based on the indication of authentication results for the particular business transaction satisfying the one or more authentication requirements of the microservice, a particular service of the one or more services as per the service request.

While there have been shown and described illustrative embodiments above, it is to be understood that various other adaptations and modifications may be made within the scope of the embodiments herein. For example, while certain embodiments are described herein with respect to certain types of networks in particular, the techniques are not limited as such and may be used with any computer network, generally, in other embodiments. Moreover, while specific technologies, protocols, and associated devices have been shown, such as JSON web tokens, HTTP headers, and so on, other suitable technologies, protocols, and associated devices may be used in accordance with the techniques described above. In addition, while certain devices are shown, and with certain functionality being performed on certain devices, other suitable devices and process locations may be used, accordingly. That is, the embodiments have been shown and described herein with relation to specific network configurations (orientations, topologies, protocols, terminology, processing locations, etc.). However, the embodiments in their broader sense are not as limited, and may, in fact, be used with other types of networks, protocols, and configurations.

In addition, certain embodiments are described herein with reference to a microservice determining whether one or more service requests satisfy one or more authentication requirements of the microservice, then based on the determining, sending a request for a device to perform authentication and/or completing a particular service, it is further contemplated that one or more agents, as described herein, may be configured to monitor any or all of the aforementioned requests, and may institute the authentication confirmation or request based on security policies instituted at the agent. That is, using instrumentation and/or monitoring techniques described herein, information (e.g., metrics, observations, etc.) may be gathered by the one or more agents, where such information may be used to monitor the presence, performance, statistics, etc. of the status of authentication processes performed by a particular application (e.g., a business application) as well as associated microservices. In this embodiment, the agent, instead of the microservice, is the process responsible for enforcing a satisfactory level of authentication for the corresponding business transaction.

Moreover, while the present disclosure contains many other specifics, these should not be construed as limitations on the scope of any embodiment or of what may be claimed, but rather as descriptions of features that may be specific to particular embodiments of particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a microservice”, those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

1. A method, comprising:
obtaining, at a device executing a microservice that provides one or more services for one or more distributed business transactions offered by an application, a first service request for a particular business transaction from the application, the particular business transaction involving a particular user device executing the application;
determining, by the device, that the first service request includes an indication of authentication results for the particular business transaction that do not satisfy one or more authentication requirements of the microservice;
sending, by the device and based on the first service request including the indication of authentication results for the particular business transaction that do not satisfy the one or more authentication requirements of the microservice, a request for the particular user device to perform authentication for the particular business transaction to satisfy the one or more authentication requirements of the microservice;
determining, by the device, that a second service request for the particular business transaction obtained from the application includes an indication of authentication results for the particular business transaction that do satisfy the one or more authentication requirements of the microservice; and
completing, by the device and based on the second service request including the indication of authentication results for the particular business transaction that do satisfy the one or more authentication requirements of the microservice, a particular service of the one or more services as per the first and second service requests.

2. The method as in claim 1, wherein the service request comprises a JavaScript object notation (JSON) web token.

3. The method as in claim 1, wherein the request for the particular user device to perform the authentication for the particular business transaction to satisfy the one or more authentication requirements comprises an HTTP 403 forbidden response.

4. The method as in claim 1, wherein the indication of authentication results is selected from a group consisting of: an indicator of authentication results; a type of authentication; a level of authentication; a timestamp of when authentication was performed; and a timer associated with authentication.

5. The method as in claim 1, wherein the microservice has an associated level of security.

6. The method as in claim 1, wherein the microservice offers a service selected from a group consisting of: payment processing; product or service tracking; data or file access; and comment posting.

7. The method as in claim 1, wherein the microservice is offered as part of a cloud native environment.

8. The method as in claim 1, wherein the microservice is separately managed and operated from the application.

9. A tangible, non-transitory, computer-readable medium having computer-executable instructions stored thereon that, when executed by a processor on a computer, cause a device executing a micro service that provides one or more services for one or more distributed business transactions offered by an application to perform a method comprising:
obtaining a first service request for a particular business transaction from the application, the particular business transaction involving a particular user device executing the application;
determining that the first service request includes an indication of authentication results for the particular business transaction that do not satisfy one or more authentication requirements of the microservice;
sending, based on the first service request including the indication of authentication results for the particular business transaction that do not satisfy the one or more authentication requirements of the microservice, a request for the particular user device to perform authentication for the particular business transaction to satisfy the one or more authentication requirements of the microservice;
determining that a second service request for the particular business transaction obtained from the application includes an indication of authentication results for the particular business transaction that do satisfy the one or more authentication requirements of the microservice; and
completing, based on the second service request including the indication of authentication results for the particular business transaction that do satisfy the one or more authentication requirements of the microservice, a particular service of the one or more services as per the first and second service requests.

10. The tangible, non-transitory, computer-readable medium as in claim 9, wherein the service request comprises a JavaScript object notation (JSON) web token.

11. The tangible, non-transitory, computer-readable medium as in claim 9, wherein the request for the particular user device to perform the authentication for the particular business transaction to satisfy the one or more authentication requirements comprises an HTTP 403 forbidden response.

12. The tangible, non-transitory, computer-readable medium as in claim 9, wherein the indication of authentication results is selected from a group consisting of: an indicator of authentication results; a type of authentication; a level of authentication; a timestamp of when authentication was performed; and a timer associated with authentication.

13. The tangible, non-transitory, computer-readable medium as in claim 9, wherein the microservice has an associated level of security.

14. The tangible, non-transitory, computer-readable medium as in claim 9, wherein the microservice offers a service selected from a group consisting of: payment processing; product or service tracking; data or file access; and comment posting.

15. The tangible, non-transitory, computer-readable medium as in claim 9, wherein the microservice is offered as part of a cloud native environment.

16. The tangible, non-transitory, computer-readable medium as in claim 9, wherein the microservice is separately managed and operated from the application.

17. An apparatus, comprising:
one or more network interfaces to communicate with a network;
a processor coupled to the one or more network interfaces and configured to execute one or more processes; and
a memory configured to store a process that is executable by the processor, the process, when executed, configured to:
obtain, at the apparatus executing a microservice that provides one or more services for one or more distributed business transactions offered by an application, a first service request for a particular business transaction from the application, the particular business transaction involving a particular user device executing the application;
determine that the first service request includes an indication of authentication results for the particular business transaction that do not satisfy one or more authentication requirements of the microservice;
send, based on the first service request including the indication of authentication results for the particular business transaction that do not satisfy the one or more authentication requirements of the microservice, a request for the particular user device to perform authentication for the particular business transaction to satisfy the one or more authentication requirements of the microservice;
determine that a second service request for the particular business transaction obtained from the application includes an indication of authentication results for the particular business transaction that do satisfy the one or more authentication requirements of the microservice; and
complete, based on the second service request including the indication of authentication results for the particular business transaction that do satisfy the one or more authentication requirements of the microservice, a particular service of the one or more services as per the first and second service requests.

18. The apparatus as in claim 17, wherein the service request comprises a JavaScript object notation (JSON) web token.

19. The apparatus as in claim 17, wherein the request for the particular user device to perform the authentication for the particular business transaction to satisfy the one or more authentication requirements comprises an HTTP 403 forbidden response.

20. The apparatus as in claim 17, wherein the indication of authentication results is selected from a group consisting of: an indicator of authentication results; a type of authentication; a level of authentication; a timestamp of when authentication was performed; and a timer associated with authentication.
